(19) United States
(12) Patent Application Publication
(10) Pub. No.: US 2015/0245202 A1
(43) Pub. Date: Aug. 27, 2015

(54) SECURE DISTRIBUTION OF A COMMON NETWORK KEY IN A WIRELESS NETWORK

(71) Applicant: QUALCOMM Incorporated, San Diego, CA (US)

(72) Inventors: Abhishek Pramod Patil, San Diego, CA (US); Soo Bum Lee, San Diego, CA (US); George Cherian, San Diego, CA (US)

(21) Appl. No.: 14/630,570

(22) Filed: Feb. 24, 2015

Related U.S. Application Data
(60) Provisional application No. 61/944,980, filed on Feb. 26, 2014.

(51) Int. Cl. H04W 12/04; H04W 12/06; H04L 9/08; H04L 29/06

(52) U.S. Cl. CPC H04W 12/04; H04L 63/08; H04W 12/06; H04L 9/0861; H04W 84/18

(57) ABSTRACT

Methods, devices, and systems are described to enable generating and securely distributing a common network key in a wireless network. For example, instead of each station of the wireless network generating a station-specific group network key, a particular station may generate and securely transmit a common network key to be used by multiple stations in the wireless network to decrypt group messages from multiple stations in the wireless network.

### I. CROSS-REFERENCE TO RELATED APPLICATIONS

The present application claims priority from U.S. Provisional Patent Application No. 61/944,980 filed on Feb. 26, 2014, the contents of which are expressly incorporated by reference in their entirety.

### II. FIELD

The present disclosure is generally related to securely distributing a common network key in a wireless network.

### III. DESCRIPTION OF RELATED ART

Advances in technology have resulted in smaller and more powerful computing devices. For example, there currently exist a variety of portable personal computing devices, including wireless computing devices, such as portable wireless telephones, personal digital assistants (PDAs), and paging devices that are small, lightweight, and easily carried by users. More specifically, portable wireless telephones, such as cellular telephones and Internet protocol (IP) telephones, can communicate voice and data packets over wireless networks. Further, many such wireless telephones include other types of devices that are incorporated therein. For example, a wireless telephone can also include a digital still camera, a digital video camera, a digital recorder, and an audio file player. Also, such wireless telephones can process executable instructions, including software applications, such as a web browser application, that can be used to access the Internet. As such, these wireless telephones can include significant computing capabilities.

A wireless network may be formed by wireless telephones and other wireless devices to communicate data between the wireless devices without management by a central node (e.g., access point) or server. For example, Institute of Electrical and Electronics Engineers (IEEE) 802.11s is a standardized set of wireless mesh network communication protocols. In 802.11s, each station (e.g., wireless device) in a wireless mesh network may generate a station-specific group network key. Each station may encrypt messages based on the station-specific group network key and may transmit encrypted group messages to neighboring stations (e.g., stations within a one hop range). In order to decrypt group messages, each station stores the group network key of each other station in the wireless mesh network. Group network keys are exchanged between neighboring stations using a peering exchange. When a particular station leaves the wireless mesh network, the neighboring stations of the particular station discard their station-specific group network keys and generate and distribute new station-specific group network keys (e.g., so that the leaving station can no longer decrypt messages transmitted via the wireless mesh network). Performing multiple peering exchanges to distribute group network keys may add significant traffic and overhead to the wireless mesh network.

### IV. SUMMARY

The present disclosure reduces key-related overhead and traffic associated with wireless networks by using a common network key. Instead of each station in the wireless network generating a corresponding group network key, a single station generates a common network key for use by each station in the wireless network. When a particular station generates the common network key, the particular station initiates transmission of a key announcement message to each other station in the wireless network. The key announcement message may be an IEEE 802.11s Root Announcement (RANK) message containing a flag field with a particular value of a reserved bit to indicate an impending or upcoming distribution and/or transmission of the common network key. In response to receiving the key announcement message, each other station in the wireless network initiates formation of a secure unicast route to the particular station. As the secure unicast routes are established, the particular station transmits the common network key to each other station via the secure unicast routes. After receiving the common network key, each station of the wireless network may encrypt and/or decrypt subsequent group messages using the common network key. When the common network key expires, the process may be repeated and a new common network key may be generated.

Each of the stations in the wireless network may be capable of generating the common network key. For example, each station may be configured to generate a random value and start a countdown from the generated random value when a previous common network key nears expiration. When the countdown at a station is complete, the station may generate a common network key and transmit a key announcement message to other stations. The other stations may stop their respective countdowns (and refrain from generating additional common network keys) in response to receiving the key announcement message. Each station may also conditionally suppress propagation of one or more additional key announcement messages and network keys based on suppression criteria.

In a particular aspect, a method includes generating a common network key at a first station of a wireless network. The common network key may enable decryption of group messages from multiple stations of the wireless network. The method includes initiating transmission of a key announcement message to each other station of the wireless network in response to generating the common network key.

In another particular aspect, an apparatus includes a processor and a memory coupled to the processor. The memory stores instructions that are executable by the processor to perform operations including generating a common network key at a first station of a wireless network. The common network key may enable decryption of group messages from multiple stations of the wireless network. The operations further include initiating transmission of a key announcement message to each of the other stations of the wireless network in response to generating the common network key.

In another particular aspect, an apparatus includes means for generating a common network key at a first station of a wireless network. The common network key may enable decryption of group messages from multiple stations of the wireless network. The apparatus further includes means for initiating transmission of a key announcement message to each of the other stations of the wireless network in response to generating the common network key.

In another particular aspect, a non-transitory computer readable medium includes instructions that, when executed by a processor, cause the processor to generate a common network key at a first station of a wireless network. The common network key may enable decryption of group messages from multiple stations of the wireless network. The instructions further cause the processor to initiate transmission of a key announcement message to each of the other stations of the wireless network in response to generating the common network key.

In another particular aspect, a method includes receiving a key announcement message at a first station of a wireless network. The key announcement message may correspond to a common network key that enables decryption of group messages from multiple stations of the wireless network. The method further includes initiating formation of a route through the wireless network from the first station to a second station indicated by the key announcement message.

In another particular aspect, an apparatus includes a processor and a memory coupled to the processor. The memory stores instructions that are executable by the processor to perform operations including receiving a key announcement message at a first station of a wireless network. The key announcement message may correspond to a common network key that enables decryption of group messages from multiple stations of the wireless network. The operations further include initiating formation of a unicast route through the wireless network to a particular station indicated by the key announcement message.

In another particular aspect, an apparatus includes means for receiving a key announcement message at a first station of a wireless network. The key announcement message may correspond to a common network key that enables decryption of group messages from multiple stations of the wireless network. The apparatus further includes means for initiating formation of a unicast route through the wireless network to a particular station indicated by the key announcement message.

In another particular aspect, a non-transitory computer readable medium includes instructions that, when executed by a processor, cause the processor to receive a key announcement message at a first station of a wireless network. The key announcement message may correspond to a common network key that enables decryption of a group messages from multiple stations of the wireless network. The instructions further cause the processor to initiate formation of a unicast route through the wireless network to a particular station indicated by the key announcement message.

In another particular aspect, a method includes determining to generate a common network key at a first station of a wireless network. The method includes, in response to determining to generate the common network key, initiating a countdown at the first station from a random value generated at the first station.

In another particular aspect, an apparatus includes a processor and a memory coupled to the processor. The memory stores instructions that are executable by the processor to perform operations including determining to generate a common network key at a first station of a wireless network. The operations further include, in response to determining to generate the common network key, initiating a countdown at the first station from a random value generated at the first station.

In another particular aspect, an apparatus includes means for determining to generate a common network key at a first station of a wireless network. The apparatus further includes means for initiating a countdown at the first station from a random value generated at the first station in response to determining to generate the common network key.

In another particular aspect, a non-transitory computer readable medium includes instructions that, when executed by a processor, cause the processor to determine to generate a common network key at a first station of a wireless network. The instructions further cause the processor to initiate a countdown at the first station from a random value generated at the first station in response to determining to generate the common network key.

In another particular aspect, a method includes receiving a first key announcement message at a first station of a wireless network. The method includes transmitting the first key announcement message to at least one station of the wireless network. The method includes receiving a second key announcement message at the first station subsequent to transmitting the first key announcement message. The method further includes determining whether to transmit the second key announcement message to the at least one station of the wireless network.

In another particular aspect, an apparatus includes a processor and a memory coupled to the processor. The memory stores instructions that are executable by the processor to perform operations including receiving a first key announcement message at a first station of a wireless network. The operations include transmitting the first key announcement message to at least one station of the wireless network. The operations include receiving a second key announcement message at the first station subsequent to transmitting the first key announcement message. The operations further include determining whether to transmit the second key announcement message to the at least one station of the wireless network.

In another particular aspect, an apparatus includes means for receiving a first key announcement message at a first station of a wireless network. The apparatus includes means for means for transmitting the first key announcement message to at least one station of the wireless network. The apparatus includes means for means for receiving a second key announcement message at the first station subsequent to transmitting the first key announcement message. The apparatus further includes means for determining whether to transmit the second key announcement message to the at least one station of the wireless network.

In another particular aspect, a non-transitory computer readable medium includes instructions that, when executed by a processor, cause the processor to receive a first key announcement message at a first station of a wireless network. The instructions cause the processor to transmit the first key announcement message to at least one station of the wireless network. The instructions cause the processor to receive a second key announcement message at the first station subsequent to transmitting the first key announcement message. The instructions further cause the processor to determine whether to transmit the second key announcement message to the at least one station of the wireless network.

One particular advantage provided by at least one of the disclosed embodiments is a reduction in key-related traffic and overhead of a wireless network as compared to a conventional wireless mesh network that operates in accordance with the IEEE 802.11s standard. For example, use of a single common network key may reduce overhead associated with exchange of multiple group keys between multiple stations. Additionally, a compromise (e.g., an unintended reception) of the common network key is unlikely due to the common network key being encrypted and transmitted via secure unicast transmissions between stations. Thus, although fewer keys are generated and in use at any given time, the disclosed wireless network may provide similar levels of network security as compared to a conventional IEEE 802.11s wireless mesh network. Other aspects, advantages, and features of the present disclosure will become apparent after review of the entire application, including the following sections: Brief Description of the Drawings, Detailed Description, and the Claims.

### V. BRIEF DESCRIPTION OF THE DRAWINGS

FIG. 1 is a diagram of a particular embodiment of a system that includes a wireless network that supports generation of a common network key and transmission of a key announcement message;

FIG. 2 illustrates a particular embodiment of a key announcement message;

FIG. 3 is a diagram illustrating transmission of the common network key in the system of FIG. 1;

FIG. 4 is a block diagram of a station configured to generate a common network key;

FIG. 5 is a diagram of illustrative examples of common network key transmission in a wireless network;

FIG. 6 is a block diagram of a particular embodiment of a system that suppresses one or more common network keys;

FIG. 7 is a flow diagram of an illustrative method of transmitting a key announcement message in a wireless network;

FIG. 8 is a flow diagram of an illustrative method of transmitting a common network key in a wireless network;

FIG. 9 is a flow diagram of an illustrative method of generating a common network key in a wireless network;

FIG. 10 is a flow diagram of an illustrative method of suppressing one or more common network keys in a wireless network; and

FIG. 11 is a diagram of a wireless device that is operable to support various embodiments of one or more methods, systems, apparatuses, and/or computer-readable media disclosed herein.

### VI. DETAILED DESCRIPTION

Particular embodiments of the present disclosure are described below with reference to the drawings. In the description, common features are designated by common reference numbers throughout the drawings.

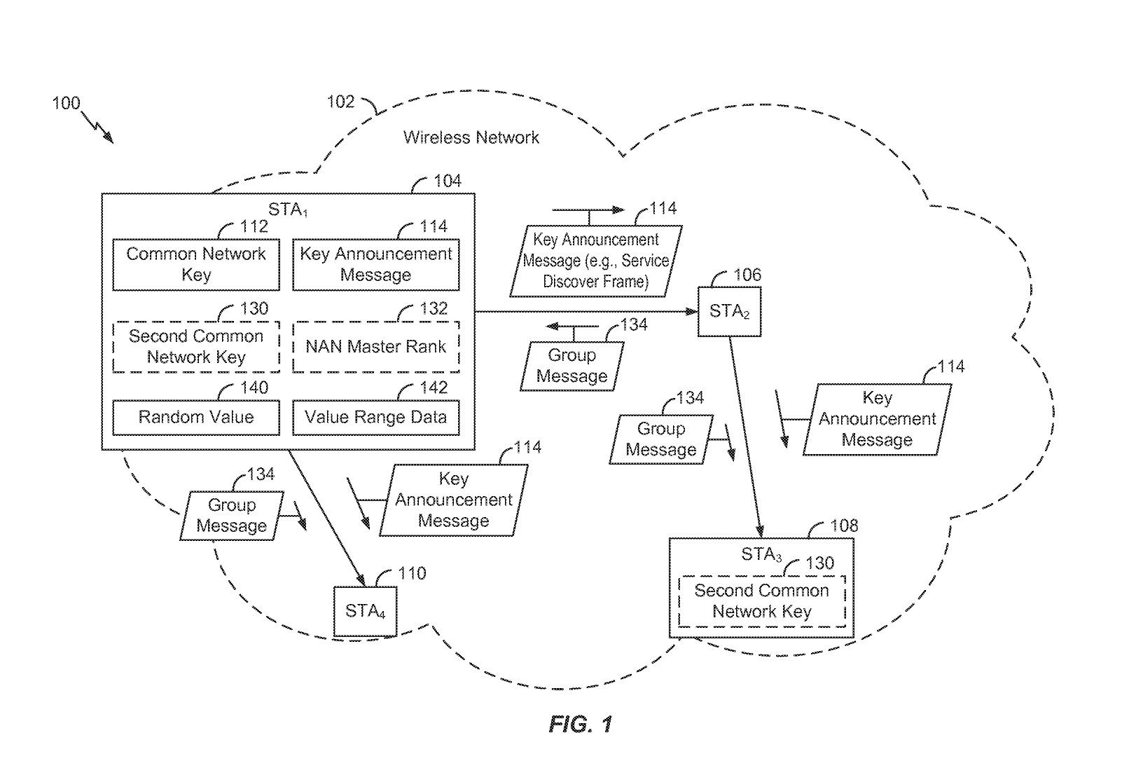

Referring to FIG. 1, a particular illustrative embodiment of a system 100 that includes a wireless network that supports generation of a common network key and transmission of a key announcement message is shown. The system 100 includes a wireless network 102 including a first station (STA₁) 104, a second station (STA₂) 106, a third station (STA₃) 108, and a fourth station (STA₄) 110.

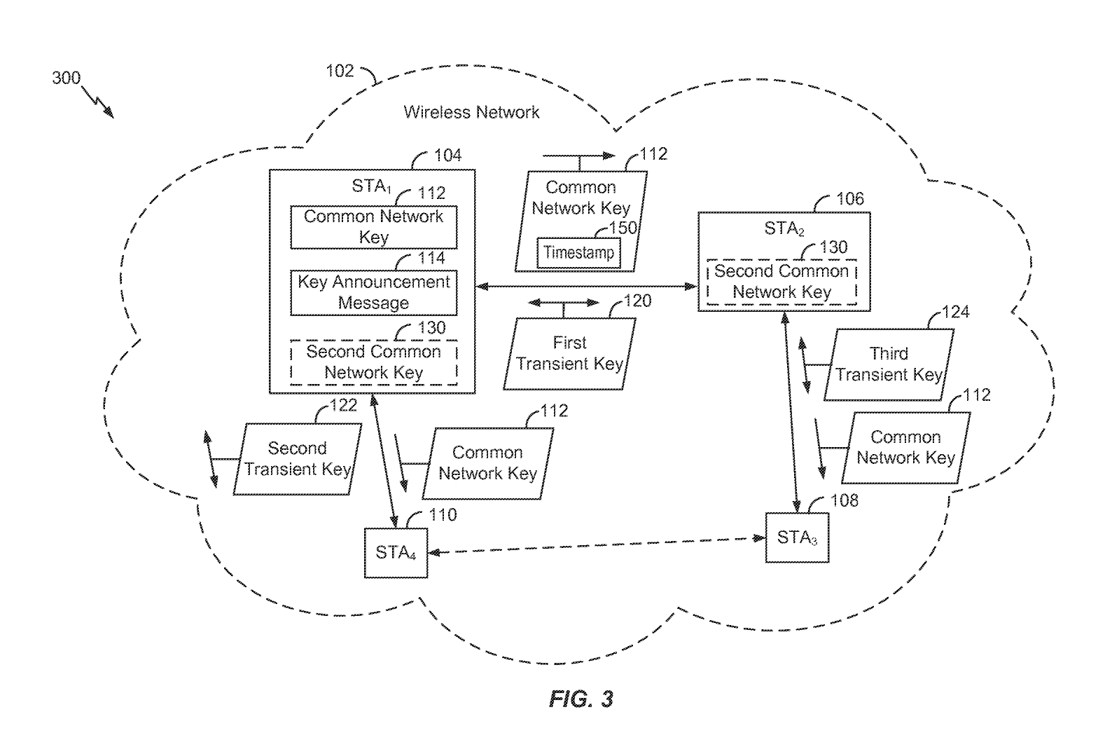

The first station 104 may be configured to generate a common network key 112. The common network key 112 may enable decryption of group messages from multiple stations of the wireless network 102, as further described herein. The first station 104 may be further configured to generate a key announcement message 114 and to transmit the key announcement message 114 to at least one of the other stations 106-110. The key announcement message 114 may be distinct from the common network key 112 and may enable stations that receive the key announcement message 114 to initiate formation of a route through the wireless network 102 to the first station 104. Each of the other stations 106-110 may be configured to receive the key announcement message 114 and to initiate formation of a secure unicast route (e.g., path) to the first station 104 in response to receiving the key announcement message 114, as further described herein with reference to FIG. 3. Additionally or alternatively, the first station 104 may be configured to generate and transmit the key announcement message 114 prior to generating (e.g., using a cryptographic key generating process) the common network key 112. The common network key 112 may be generated during formation of unicast routes from the other stations 106-110 to the first station 104, as further described with reference to FIG. 3.

Each of the stations 104-110 may enter and leave the wireless network 102. In a particular embodiment, the wireless network 102 includes a wireless mesh network (e.g., an IEEE 802.11s wireless mesh network). In another particular embodiment, the wireless network 102 includes a peer-to-peer, infrastructure-less wireless network. In yet another particular embodiment, the wireless network 102 includes a data path group of a neighbor aware network (NAN). In another particular embodiment, the wireless network 102 may be a “social wi-fi mesh network.” The wireless network 102 may operate in accordance with one or more standards, such as an Institute of Electrical and Electronics Engineers (IEEE) 802.11 standard, a Wi-Fi Alliance standard, another wireless communication standard, or a combination thereof. As used herein, the wireless network 102 may support transmissions according to the IEEE 802.11s standard, as an illustrative, non-limiting example, or a Wi-Fi Alliance standard, as another non-limiting example.

Each of the stations 104-110 may be a wireless communication device configured to transmit data and/or receive data from one or more other wireless communication devices in the wireless network 102. For example, the stations 104-110 may include a processor (e.g., a central processing unit (CPU), a digital signal processor (DSP), a network processing unit (NPU), etc.), a memory (e.g., a random access memory (RAM), a read-only memory (ROM), etc.), and/or a wireless interface configured to send and receive data via a wireless network, as described further with reference to FIG. 10. Each of the stations 104-110 may be configured to act in accordance with one or more standards, such as the IEEE 802.11s standard and/or a Wi-Fi Alliance standard.

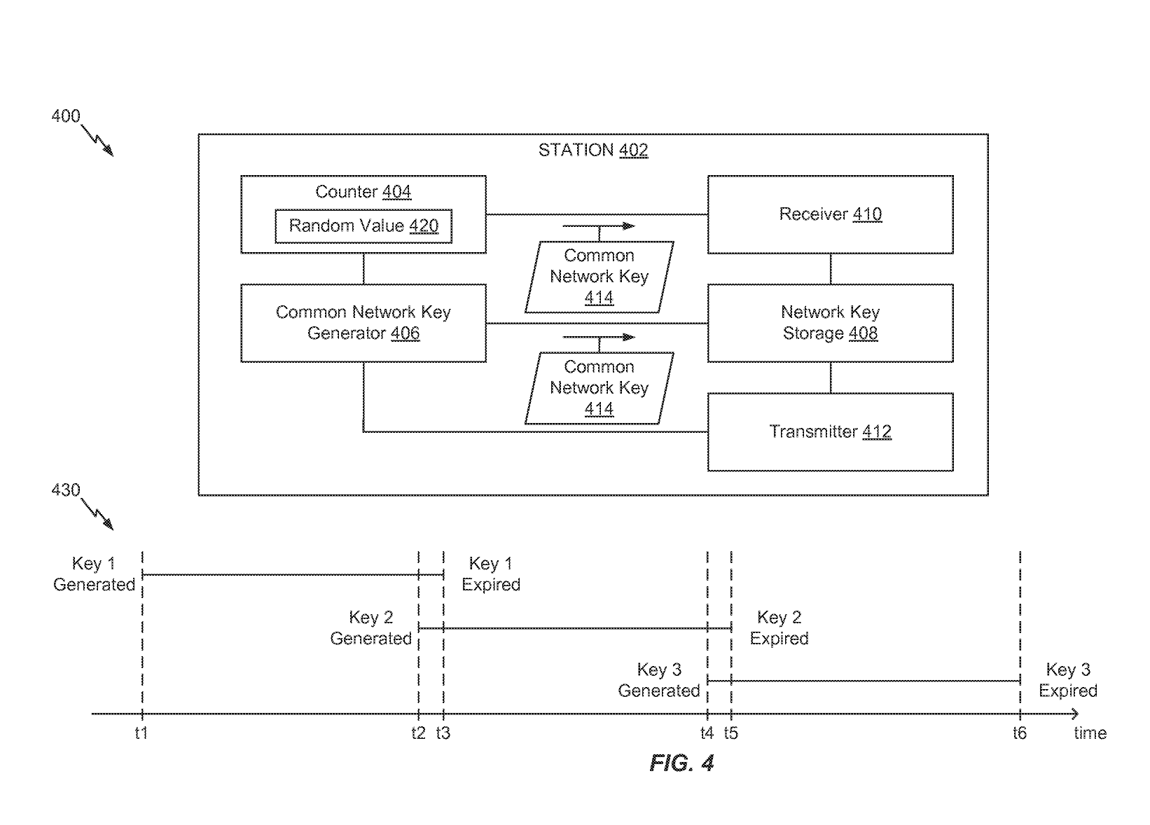

During operation, the first station 104 may be configured to generate the common network key 112. For example, the first station 104 may generate the common network key 112 in response to completing a countdown from a random value 140, or a pseudo-random value, as further described with reference to FIG. 4. The random value 140 may be selected from a range of values indicated by value range data 142, as further described with reference to FIG. 4. The common network key 112 may enable each station in the wireless network to encrypt and/or decrypt group messages (e.g., transmissions). For example, after each of the stations 104-110 has received the common network key 112, a particular station (e.g., the second station 106) may encrypt a group message 134 using the common network key 112 and may transmit the encrypted group message 134 to one or more of the stations 104, 108, and 110, as further described with reference to FIG. 3. Each of the stations 104, 108, and 110 that receive the encrypted group message 134 may decrypt the encrypted group message 134 based on the common network key 112.

The first station 104 may be configured to generate the key announcement message 114 in response to generating the common network key 112 and before distributing the common network key 112 to the other stations 106-110. The key announcement message 114 may be generated as a group message (e.g., may be addressed to multiple stations) and/or as a broadcast message. The first station 104 may be configured to encrypt the key announcement message 114 using a previous common network key, as further described with reference to FIG. 4.

In a particular embodiment, a second common network key 130 stored at the first station 104 may be used by stations of the wireless network 102 to encrypt group messages prior to a particular time when the common network key 112 originates (e.g., is generated). Additionally, the second common network key 130 may be used to decrypt group messages received from other stations. In this embodiment, the first station 104 may be configured to detect an expiration time of the second common network key 130 and to determine to generate the common network key 112 and the key announcement message 114 prior to the expiration time of the second common network key 130. The first station 104 may be further configured to initiate transmission of the key announcement message 114 (and the common network key 112, as described with reference to FIG. 3) prior to the expiration time of the second common network key 130. Transmitting the key announcement message 114 (and the common network key 112) prior to the expiration time of the second common network key 130 may enable the stations 106-110 to avoid a time period during which the stations 106-110 do not have a valid common network key (e.g., a time period when no common network key is “current” or “in use”).

After generating and encrypting the key announcement message 114, the first station 104 may be configured to initiate transmission of (e.g., broadcast) the key announcement message 114 to each other station 106-110 in the wireless network 102. In a particular embodiment, the key announcement message 114 may be a broadcast message and one or more stations may receive and forward the key announcement message 114 so that the key announcement message 114 reaches each station in the wireless network 102. For example, the first station 104 may transmit (e.g., broadcast) the key announcement message 114 to the second station 106 and the fourth station 110. The second station 106 and the fourth station 110 may be referred to as “neighboring” stations of the first station 104 because the stations 106 and 110 are within a particular range (e.g., a one-hop range) of the first station 104, as described by the IEEE 802.11s standard and/or a Wi-Fi Alliance standard.

The key announcement message 114 may continue to propagate through the wireless network 102 until each station of the wireless network 102 has received the key announcement message 114. For example, the second station 106 may receive the key announcement message 114 and forward (e.g., retransmit or rebroadcast) the key announcement message 114 to the third station 108. In this example, the key announcement message 114 may reach the third station 108 via a multi-hop route (e.g., via transmission from multiple stations). Additionally or alternatively, the first station 104 or the fourth station 110 may transmit the key announcement message 114 to the third station 108 if either of the first station 104 or the fourth station 110 is within the particular range of the third station 108. In response to receiving the key announcement message 114, each of the other stations 106-110 may stop a respective countdown, as further described with reference to FIG. 4.

The first station 104 may be configured to transmit the key announcement message 114 during a “paging window” (e.g., a time period of active stations) associated with the wireless network 102. For example, stations in the wireless network 102 may be configured to transmit and/or receive data during one or more transmission windows. A corresponding paging window pre-pends (e.g., precedes) each transmission window. During each paging window, each station in the wireless network “wakes up” (e.g., transitions from a power-save or sleep mode to an active mode) and listens for one or more messages (e.g., beacons) indicating traffic to be sent to the station during a corresponding transmission window. If a station does not receive a message indicating upcoming data during the paging window, the station “goes to sleep” (e.g., enters a sleep mode) during the following transmission window. Thus, each of the stations 104-110 is configured to receive messages (e.g., is awake) during each paging window associated with the wireless network 102. The stations 104-110 also synchronize their clocks, as described by the IEEE 802.11s standard and/or a Wi-Fi Alliance standard, to enable the stations 104-110 to determine when paging windows and transmission windows begin and end, respectively.

The first station 104 may transmit the key announcement message 114 during a paging window so that each other station 106-110 is awake and able to receive the key announcement message 114. When the stations 106-110 receive the key announcement message 114, the stations 106-110 may be configured to remain awake during a corresponding transmission window (or a portion thereof) to request and to receive the common network key 112. For example, the stations 106-110 may request the common network key 112 from the first station 104 and the first station 104 may, in response to the requests, transmit the common network key 112 to the stations 106-110 via secure unicast routes, as further described with reference to FIG. 3.

In a particular embodiment, each of the stations 104-110 may also be part of a neighbor aware network (NAN). One or more wireless communication channels may be reserved for discovery operations and synchronization operations by devices of the NAN. In this embodiment, the key announcement message 114 may be a service discovery message associated with the NAN. The first station 104 may transmit the key announcement message 114 as a service discovery message via a NAN wireless communication channel to the stations 106, 108, and 110.

Additionally, determining to generate the key announcement message 114 and the common network key 112 may be based on information related to the NAN. In a particular embodiment, each device in the NAN may store a NAN master rank 132. The NAN master rank 132 may indicate, for a particular device, a ranking associated with the particular station acting as a NAN master device (e.g., a device that provides synchronization and other information to other devices of the NAN). In a particular embodiment, the first station 104 may determine to generate the common network key 112 and the key announcement message 114 based on determining that the NAN master rank 132 of the first station 104 exceeds other NAN master ranks of other devices in the NAN (e.g., that the first station 104 is to act as the NAN master device).

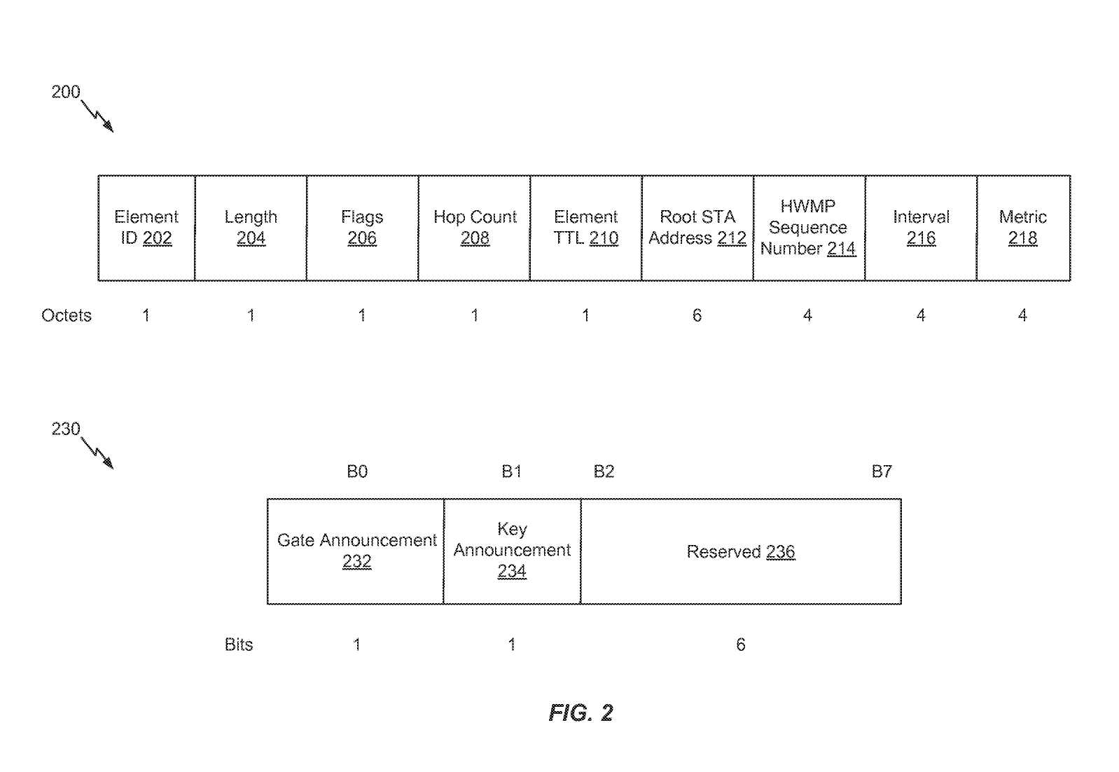

In another particular embodiment, the key announcement message 114 may be formatted as a modified (e.g., repurposed) IEEE 802.11s Root Announcement (RANN) message. FIG. 2 illustrates a diagram 200 of an illustrative key announcement message, such as the key announcement message 114 of FIG. 1. The key announcement message includes an element identification (ID) field 202, a length field 204, a flags field 206, a hop count field 208, an element time-to-live (TTL) field 210, a root station address field 212, a hybrid wireless mesh protocol (HWMP) sequence number field 214, an interval field 216, and a metric field 218. The diagram 200 also indicates a number of octets (e.g., multiples of 8 bits) of data contained in each field. Additionally, the key announcement message 114 may conform to another standard, such as a Wi-Fi Alliance standard.

The key announcement message 114 may indicate an upcoming transmission of the common network key 112 based on a bit value in the flags field 206. FIG. 2 illustrates a diagram 230 of the flags field 206. The flags field 206 includes a 1-bit gate announcement bit 232, a 1-bit key announcement bit 234, and multiple (e.g., 6) reserved bits 236. In an IEEE 802.11s RANN message, B0 (e.g., a most significant bit (MSB)) is the gate announcement bit and bits B1-B7 are reserved bits, as described in the IEEE 802.11s standard. The key announcement message 114 of the present disclosure modifies the conventional IEEE 802.11s RANN message by using one of the reserved bits as the key announcement bit 234. In the example illustrated in FIG. 2, the key announcement bit 234 is the second bit (e.g., B1) of the flags field 206, and bits B2-B7 are reserved bits. Additionally or alternatively, the key announcement bit 234 may be any of the bits B2-B7, and B1 may be a reserved bit. In a particular embodiment, a value of one in the key announcement bit 234 may indicate that the message is a key announcement message. In an alternate embodiment, a value of zero in the key announcement bit 234 may indicate that the message is a key announcement message.

A station that receives the key announcement message 114 may determine that another station has generated a common network key based on the key announcement bit 234, and may identify a source (e.g., generator) of the common network key based on the root station address field 212. For example, the root station address field 212 of the key announcement message 114 may indicate a media access control (MAC) address of the first station 104 (e.g., an “originating” station that originally transmitted the key announcement message 114). Based on the key announcement bit 234 and the root station address field 212, the stations 106-110 may initiate formation of a secure unicast route to the first station 104, as further described with reference to FIG. 3, to receive the common network key 112.

By using a single network key (e.g., the common network key 112) instead of station-specific group network keys generated by each station in the wireless network 102, the system 100 may reduce overhead and traffic associated with storing and exchange of network keys. Further, because the key announcement message 114 may be similar to an IEEE 802.11s RANK message, few modifications to an IEEE 802.11s wireless mesh network are made to enable use of a common network key in accordance with the described techniques.

FIG. 3 illustrates transmission of the common network key 112 in the system of FIG. 1 and is generally designated 300. During operation, the first station 104 may generate and may transmit the key announcement message 114 to each other station 106-110. Each of the stations 106-110 may be configured to initiate formation of a unicast route to the first station 104 in response to receiving the key announcement message 114. Forming a secure unicast route between stations may enable secure transmission of the common network key 112.

A unicast route may refer to one or more portions (e.g., hops) of a transmission path between two stations. For example, the second station 106 and the fourth station 110 may form “direct” unicast routes to the first station 104 because the second station 106 and the fourth station 110 are within one hop of the first station 104. The third station 108 may form a unicast route to the first station 104 via the second station 106. Each of the unicast routes may be a “best path” (e.g., a shortest path) formed based on route determination methods or algorithms according to the IEEE 802.11s standard and/or a Wi-Fi Alliance standard. For example, the third station 108 and the fourth station 110 may be capable of communicating (as illustrated by the dashed line in FIG. 3), but the third station 108 may form the unicast route to the first station 104 via the second station 106 instead of via the fourth station 110 based on one or more route determination methods or algorithms.

In a particular embodiment, forming a unicast route may include performing an authentication process between two stations. For example, forming a unicast route from the second station 106 to the first station 104 may include the first station 104 and the second station 106 performing an authentication process. The authentication process may be performed using a preshared key. The authentication process may be in accordance with authentication processes described in the IEEE 802.11s standard and/or a Wi-Fi Alliance standard. In response to a successful authentication, a first “transient” key 120 is generated. The first transient key 120 may be generated by one of the first station 104 or the second station 106 and may be shared between the two stations. The first station 104 and the second station 106 may each store the first transient key 120 and may use the first transient key 120 to enable secure unicast transmission of the common network key 112, such as by encryption and decryption based on the first transient key 120. Other stations in the wireless network 102 may be configured to similarly form unicast routes. As an example, the fourth station 110 may form a unicast route to the first station 104 and may exchange (e.g., share) a second transient key 122. As another example, the third station 108 may form a unicast route to the second station 106 and may exchange a third transient key 124.

In a particular embodiment, after formation of the secure unicast routes, the stations 106-110 may request the common network key 112 from the first station 104. In response to the requests, the first station 104 may transmit the common network key 112 to the stations 106-110 via the secure unicast routes. For example, the first station 104 may encrypt the common network key 112 based on the second transient key 122 and may transmit the encrypted common network key 112 to the fourth station 110 via a unicast transmission. The fourth station 110 may receive and may decrypt the encrypted common network key 112 based on the second transient key 122. As another example, the first station 104 may encrypt the common network key 112 based on the first transient key 120 and may transmit the encrypted common network key 112 to the second station 106 via a unicast transmission. The second station 106 may receive and may decrypt the encrypted common network key 112 based on the first transient key 120. Additionally, the second station 106 may encrypt the common network key 112 based on the third transient key 124 and may transmit the encrypted common network key 112 to the third station 108 via a unicast transmission. The third station 108 may receive and may decrypt the encrypted common network key 112 based on the third transient key 124. Thus, the common network key 112 may be propagated to each station in the wireless network 102 via a series of secure, station-to-station unicast transmissions. In a particular embodiment, after propagation of the common network key 112, the transient keys 120-124 may be discarded.

In an alternate embodiment, the common network key 112 may be encrypted based on a shared key (e.g., a pairwise traffic key (PTK)) established by the stations during an authentication and security association process. For example, the first station 104 and the second station 106 may perform an authentication and security association process when the second station 106 joins the wireless network 102, and during the authentication and security association process, the first station 104 and the second station 106 may share a PTK. After generating of the common network key 112, the first station 104 may encrypt the common network key 112 based on the PTK. The PTK may be based on a group authentication key, a password, a secret credential, or a combination thereof, as non-limiting examples. In a particular embodiment, the PTK is generated using a 4-way handshake protocol specified in the IEEE 802.11ai standard, or a modified 802.11ai 4-way handshake protocol. In a similar manner, when propagating the common network key 112 to other stations, the stations 106-110 may encrypt the common network key 112 based on PTKs shared with the other stations.

In a particular embodiment, the common network key 112 may be associated with timing information, such as a timestamp 150 that indicates a time when the common network key 112 originated. The timestamp 150 may be used by one or more of the stations 104-110 to determine an expiration of the common network key 112, as further described with reference to FIG. 4. The first station 104 may be configured to transmit the timestamp 150 with the common network key 112. In a particular embodiment, the timestamp 150 may be appended to the common network key 112 in one or more transmission packets or may be encoded into the common network key 112.

In a particular embodiment, the common network key 112 may expire after a particular amount of time, as further described with reference to FIG. 4. In a particular embodiment, at least one of the stations 104-110 may generate a second (e.g., next or “new”) common network key prior to expiration of the common network key 112. The second common network key may be propagated through the wireless network 102 similarly to the common network key 112, as described above.

In a particular embodiment, messages (e.g., group messages) in the wireless network are encrypted and decrypted using the common network key 112. For example, the second station 106 may generate a message (e.g., the group message 134) addressed to one or more of the stations 104, 108, and 110. The second station 106 may encrypt the message based on the common network key 112 and may initiate transmission of the encrypted message. In a particular embodiment, the encrypted message may be broadcast to each of the stations 104, 108, and 110. Each of the stations 104, 108, and 110 may receive and decrypt the encrypted message based on the common network key 112. Although the second station 106 is described as generating, encrypting, and initiating transmission of the message, each of the stations 104-110 may generate, encrypt, and initiate transmission of the message or may receive and decrypt the message based on the common network key 112. Additionally, although the first station 104 is described as generating and/or storing the common network key 112, the key announcement message 114, the second common network key 130, the NAN master rank 132, the random value 140, and the value range data 142, each of the stations 106-110 may be configured to perform the operations described with reference to the first station 104.

By using a single network key (e.g., the common network key 112), the system 100 reduces traffic and overhead associated with conventional IEEE 802.11s wireless mesh networks by reducing a number of authentication processes performed. As illustrated in FIG. 3, a particular station performs the authentication process with another station that is along a unicast route to the first station 104, as opposed to performing the authentication process with each neighboring station. For example, the third station 108 and the fourth station 110 do not perform the authentication process because the fourth station 110 is not along the unicast transmission route from the third station 108 to the first station 104. Reducing the number of authentication processes performed reduces traffic in the wireless network 102 as well as memory used by each station to store additional authentication keys used during the authentication process. Additionally, each station does not have to generate and exchange a new group network key each time a neighboring station leaves the wireless network 102, as compared to other IEEE 802.11s wireless mesh networks.

Although FIGS. 1-3 describe the first station 104 as generating the common network key 112 and the key announcement message 114, each of the stations 104-110 may be capable of generating a common network key and a key announcement message upon determining that a previous common network key is about to expire. In order to limit a number of common network keys and key announcement messages that are generated, each of the stations 104-110 may be configured to generate common network keys based on a countdown from the random value 140, or a pseudo-random value, as further described herein.

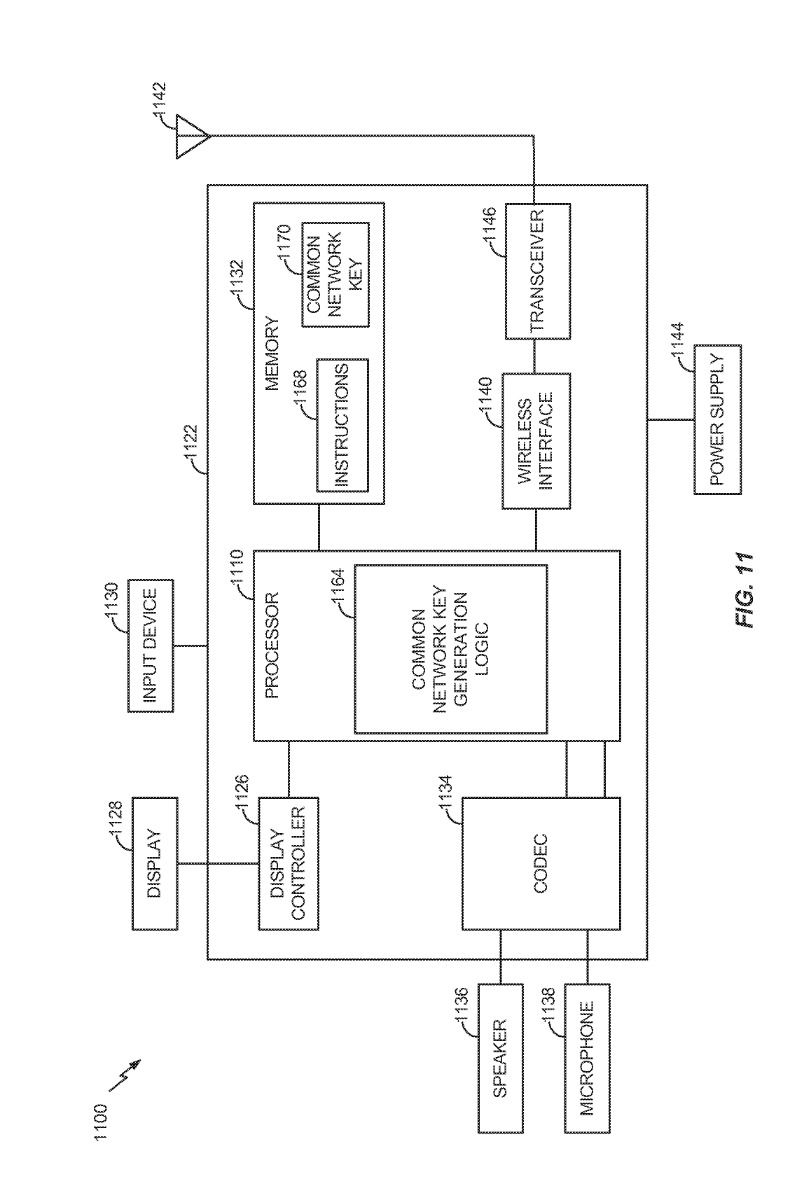

FIG. 4 is a particular illustrative embodiment of a system 400 that generates a common network key. The system includes a station 402, such as a station in a wireless network. The station 402 may include or correspond to the stations 104-110 of the wireless network 102 of FIGS. 1 and 3. Additionally or alternatively, components of the station 402 may be part of or may be executed by a processor configured to perform one or more operations to generate a common network key, as described with reference to FIG. 11.

The station 402 may include a counter 404, a common network key generator 406, network key storage 408, a receiver 410, and a transmitter 412. In an alternate embodiment, the receiver 410 and the transmitter 412 may comprise a single component, such as a transceiver. Additionally or alternatively, a timer may be included in or may replace the counter 404. The counter 404 may be coupled to the common network key generator 406 and to the receiver 410, the common network key generator 406 may be coupled to the network key storage 408 and to the transmitter 412, and the network key storage 408 may be coupled to the receiver 410 and to the transmitter 412.

The common network key generator 406 may be configured to generate a common network key 414 and provide the common network key 414 to the network key storage 408 and to the transmitter 412. The counter 404 may be configured to perform a countdown from a random value 420 prior to generating the common network key 414, as further described herein. The network key storage 408 may be configured to store one or more network keys, such as the common network key 414. As another example, the network key storage 408 may store one or more previous common network keys (e.g., one or more common network keys generated prior to the common network key 414). The receiver 410 and the transmitter 412 may be configured to receive one or more signals from and to transmit one or more signals to other stations of a wireless network, respectively.

During operation, the common network key generator 406 may initiate formation of the common network key 414. In a particular embodiment, the network key storage 408 may store a previous common network key, and the common network key generator 406 may initiate formation of the common network key 414 based on detecting an expiration indicator associated with the previous common network key. In a particular embodiment, detection of the expiration indicator may be based on a timestamp associated with the previous common network key.

FIG. 4 also illustrates timing associated with expiration of network keys (e.g., common network keys) in a timing diagram 430. As illustrated, a first network key (Key 1) may be generated at time t1. Time t1 may be indicated by a timestamp transmitted with the first network key, as described with reference to FIG. 3. At time t2, a second network key (Key 2) is generated. At time t3, the first network key expires. Although illustrated as being generated at time t2, in other examples a station may determine to generate the second network key at time t2, and the second network key may be generated at some time between time t2 and time t3.

In a particular embodiment, the above-mentioned expiration indicator may include an amount of time remaining before expiration of the first network key at time t3. The amount of time may be indicated by a threshold time (e.g., time t2). The threshold time may be selected such that the amount of time remaining before expiration of the first network key is sufficient for the second network key to be generated and propagated to each station in the wireless network prior to expiration of the first network key at time t3. In a particular embodiment, the threshold time is a duration or time period after a common network key is generated, and the threshold time is stored at each station in the wireless network. For example, in the timing diagram 430, a third network key (Key 3) may be generated at time t4 prior to expiration of the second network key at time t5. An amount of time (e.g., a duration or time period) between time t2 and time t3 is the same as an amount of time between time t4 and time t5. Similarly, an amount of time between time t1 and time t2 is the same as an amount of time between time t2 and time t4. The threshold time, detected at time t2 or time t4, may be detected using a countdown from the time a network key is generated (e.g., time t1 or time t2) via the counter 404 or other counting or timing logic in the station 402.

In another particular embodiment, the expiration indicator may be based on a number of stations in the wireless network. For example, the expiration indicator may include a number of stations that joined the wireless network subsequent to a particular time when the previous common network key originated (e.g., is generated). As another example, the expiration indicator may include a number of stations that exited the wireless network subsequent to a particular time when the previous common network key originated.

In response to detecting the expiration indicator, the common network key generator 406 may determine to generate the common network key 414. The common network key generator 406 may cause the counter 404 to initiate a countdown from the random value 420. In a particular embodiment, the random value 420 may be generated and/or selected from within a particular range of values stored at station 402. For example, the station 402 may be programmed with data (e.g., the value range data 142) indicating the particular range of values during manufacture. As another example, the station 402 may receive the particular range of values from another station during an authentication and/or an association process. In a particular embodiment, the particular range of values is specified by the IEEE 802.11 standard and/or a Wi-Fi Alliance standard. When the countdown reaches zero, the common network key generator 406 may generate the common network key 414 and provide the common network key 414 to the network key storage 408 and to the transmitter 412. Additionally, the common network key generator 406 may generate a key announcement message (e.g., the key announcement message 114) and may cause the key announcement message to be transmitted by the transmitter 412 prior to transmitting the common network key 414, as described with reference to FIG. 1. The common network key 414 may be stored in the network key storage 408 for use in encrypting and decrypting group messages from or to the wireless network, as described with reference to FIG. 3. The common network key 414 (and the key announcement message) may be transmitted by the transmitter 412 to each other station in the wireless network (e.g., via single-hop or multi-hop routes). In a particular embodiment, the key announcement message may be encrypted based on the previous common network key prior to transmission. The common network key 414 may be transmitted via one or more unicast transmissions, as described with reference to FIG. 3.

The common network key generator 406 may be configured to prevent (e.g., prohibit) the common network key 414 from being generated when another key announcement message or another common network key is received prior to completion of the countdown. For example, the counter 404 may stop the countdown if a second key announcement message or a second common network key (e.g., a key announcement message or a common network key generated by a different station) is received by the receiver 410. The common network key generator 406 may not generate the common network key 414 if the countdown does not reach a zero value.

Although FIG. 4 illustrates a single station 402, each station in the wireless network may be similarly configured to the station 402. Thus, any station in the wireless network may generate the common network key 414. By enabling each station in the wireless network to generate the common network key 414, the wireless network may experience the advantages of using the common network key 414, as described with reference to FIGS. 1-3, without having a single central station configured to generate the common network key 414. Use of a single central station may be undesirable in a wireless network, because each station (including the central station) may leave the wireless network at any time.

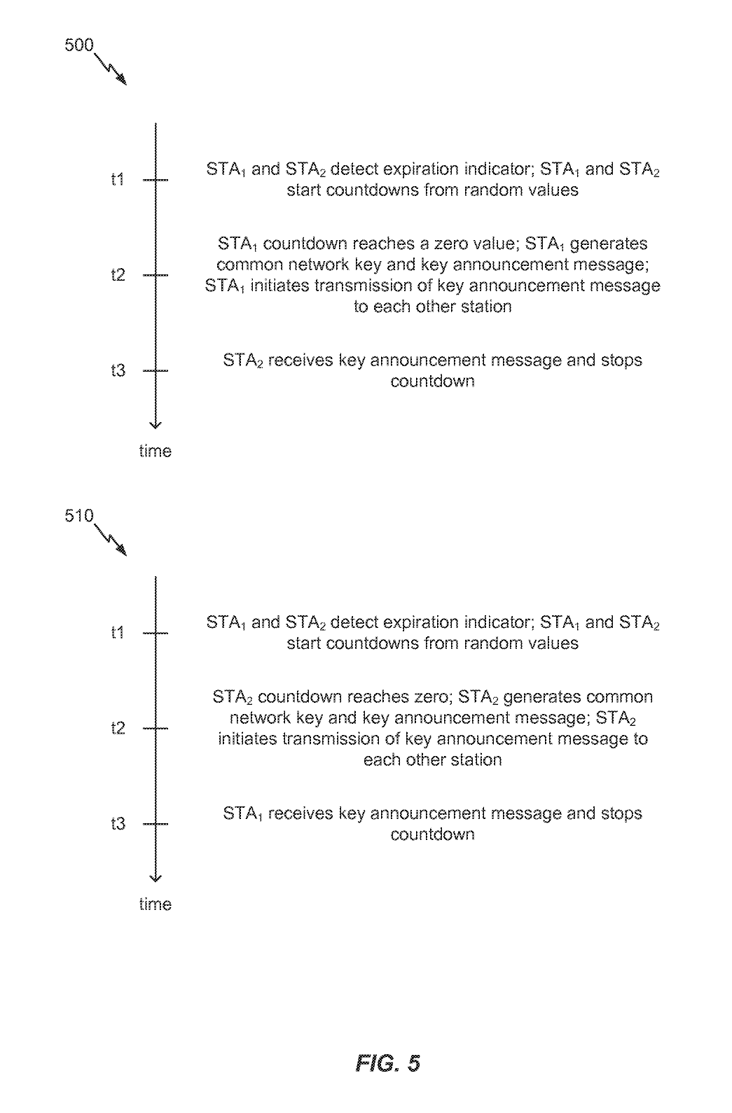

FIG. 5 illustrates a timing diagram of a first illustrative example of common network key transmission in a wireless network that is generally designated 500. FIG. 5 also illustrates a timing diagram of a second illustrative example of common network key transmission in a wireless network that is generally designated 510. The timing diagrams 500-510 illustrate communication between two stations in the wireless network, such as two of the stations 104-110 of FIGS. 1 and 3 or the station 402 of FIG. 4 and another station.

In timing diagram 500, at a first time (t1), a first station (STA₁) and a second station (STA₂) each detect an expiration indicator. For example, the expiration indicator may be a particular amount of time that remains before expiration of a previous common network key, a number of stations that joined the wireless network subsequent to a particular time when the previous common network key originated, a number of stations that exited the wireless network subsequent to a particular time when the previous common network key originated, or a combination thereof, as described with reference to FIG. 4. In response to detecting the expiration indicator, the first station and the second station each start a countdown from a respective random value, as described with reference to FIG. 4.

At a second time (t2), the countdown at the first station reaches a zero value. Thus, in the example of the timing diagram 500, the random value generated by the first station is lower than the random value generated by the second station. Accordingly, the countdown at the first station is completed prior to the countdown at the second station. In response to completing the countdown, the first station generates a common network key and a key announcement message, as described with reference to FIG. 1. The first station initiates transmission of the key announcement message to the other stations of the wireless network.

At a third time (t3), the second station receives the key announcement message. In response to receiving the key announcement message, the second station stops the countdown at the second station (therefore refraining from generating another common network key), as described with reference to FIG. 4.

In the example associated with the timing diagram 510, the random value generated by the second station is lower value than the random value generated by the first station. Accordingly, the countdown at the second station is completed prior to the countdown at the first station. At a second time (t2), the countdown at the second station reaches a zero value. In response to completing the countdown, the second station generates a common network key and a key announcement message. The second station initiates transmission of the key announcement message to the other stations of the wireless network. At a third time (t3), the first station receives the key announcement message. In response to receiving the key announcement message, the first station stops the countdown (therefore refraining from generating another common network key). As shown by the examples associated with timing diagrams 500 and 510, each station in the wireless network may generate the common network key.

As shown in FIG. 5, generated more than one common network key may be prevented due to stations stopping respective countdowns when a key announcement message is received. In smaller wireless networks, a first key announcement message may reach each station in the wireless network prior to completion of a respective countdown at each station. However, in larger wireless networks, distance between stations may result in multiple key announcement messages and multiple common network keys being generated. For example, a first station may generate and transmit a first key announcement message at a first time. A second station may generate and transmit a second key announcement message at a second time prior to receiving the first key announcement message. To account for multiple key announcement messages and multiple common network keys, each station may be configured to perform key suppression.

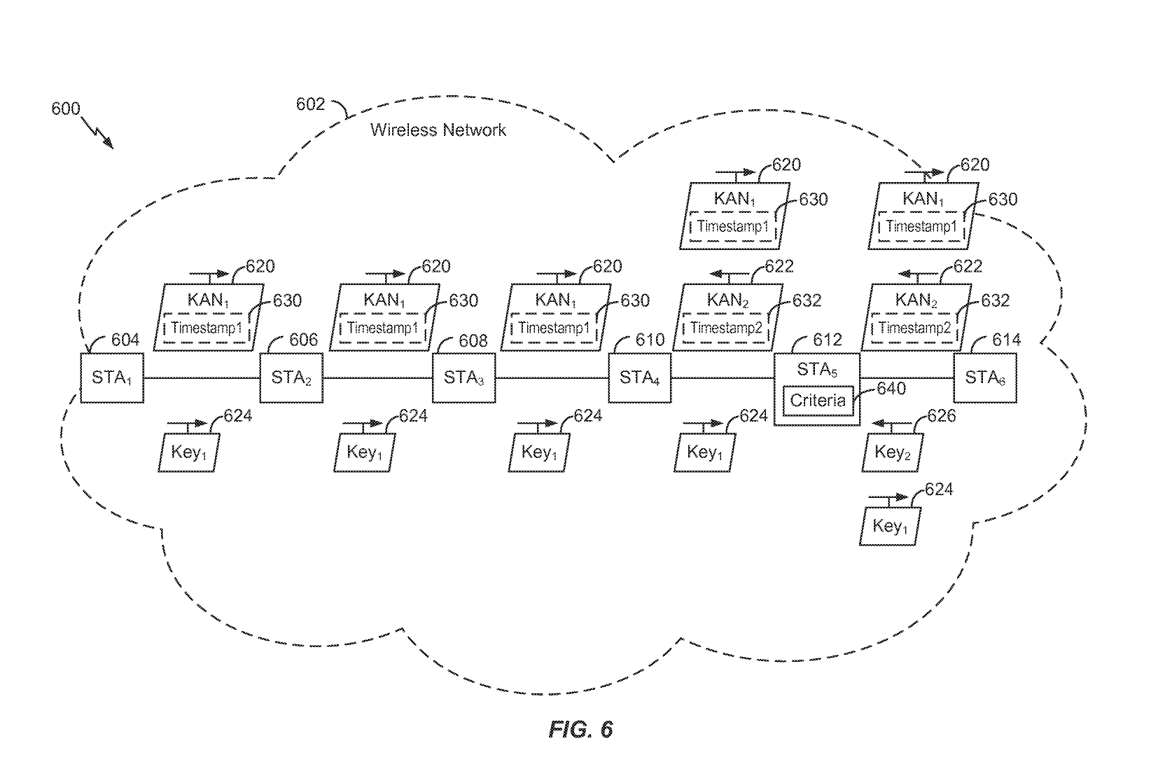

FIG. 6 is a particular embodiment of a system 600 that suppresses one or more common network keys. The system 600 includes a wireless network 602, a first station (STA₁) 604, a second station (STA₂) 606, a third station (STA₃) 608, a fourth station (STA₄) 610, a fifth station (STA₅) 612, and a sixth station 614 (STA₆). In FIG. 6, the stations 604-614 are illustrated in a straight line for convenience only. The stations 604-614 may be physically arranged in any manner and in any location within the wireless network 602. The wireless network 602 may include or correspond to the wireless network 102 of FIGS. 1 and 3, and the stations 604-614 may include or correspond to the stations 104-110 of FIGS. 1 and 3 or the station 402 of FIG. 4.

The wireless network 602 may be configured to operate according to one or more standards, such as the IEEE 802.11s standard and/or a Wi-Fi Alliance standard as non-limiting examples. Each of the stations 604-614 may be configured to send and receive transmissions via the wireless network 602, as described with reference to FIGS. 1 and 3. Each of the stations 604-614 may be further configured to generate a common network key after completion of a countdown from a respective random value, as described with reference to FIGS. 4-5.

Each of the stations 604-614 may be further configured to suppress one or more key announcement messages and/or one or more common network keys based on at least one key suppression criteria. As illustrated in FIG. 6, the fifth station 612 stores at least one key suppression criteria 640. Such illustration is for convenience only, and each of the stations 604-614 may store the at least one key suppression criteria 640. Additionally, each of the stations 604-614 may be configured to determine whether to transmit a received key announcement message and/or a received common network key based on the at least one key suppression criteria 640. In a particular embodiment, the at least one key suppression criteria 640 is the same for each of the stations 604-614. In a particular embodiment, the at least one key suppression criteria 640 may be based on whether a particular station has received any other key announcement messages or common network keys (e.g., a first-received key announcement message or common network key may be transmitted).

In another particular embodiment, the at least one key suppression criteria 640 may be based on a time when the key announcement message or the common network key originated. For example, the fifth station 612 may determine to transmit a key announcement message (or a common network key) may be based on whether the key announcement message (or the common network key) was generated before an earlier-received key announcement message (or an earlier-received common network key). The fifth station 612 may determine to transmit the key announcement message based on timestamps included in the key announcement messages. For example, a first key announcement message 620 may include a first timestamp 630 and a second key announcement message 622 may include a second timestamp 632. In a particular embodiment, the at least one key suppression criteria 640 is based on whether the first timestamp 630 occurred before the second timestamp 632. As another example, the fifth station 612 may determine to transmit a key announcement message (or a common network key) based on determining whether the key announcement message (or the common network key) was generated after an earlier-received key announcement message (or an earlier-received common network key).

In another particular embodiment, the at least one key suppression criteria 640 may be based on a comparison of a threshold and a difference between a timestamp included in a key announcement message and a time indicator (e.g. an indication of a current time) at a particular station. For example, the fifth station 612 may determine whether to suppress (e.g., to not transmit) the second key announcement message 622 when a difference between the second timestamp 632 and the time indication (e.g. of a current time) at the fifth station 612 exceeds a threshold. In a particular embodiment, the threshold may be based on a validity time period of common network keys in the wireless network 602.

In another particular embodiment, the at least one key suppression criteria 640 may be based on a media access control (MAC) address included in the key announcement message. For example, a station may determine to transmit or to not transmit the key announcement message based on the MAC address (e.g., a MAC address indicated by the root station address field 212 of FIG. 2).

In another particular embodiment, the at least one key suppression criteria 640 may be based on network seniority of an originating station of the key announcement message (or the common network key). For example, a station may determine to transmit the key announcement message (or the common network key) based on whether the originating station of the key announcement message (or the common network key) has greater network seniority (e.g., priority) than the originating station of the earlier-received key announcement message (or an earlier-received common network key). Additionally or alternatively, the at least one key suppression criteria 640 may include or may be based on other key suppression criteria.

In response to determining not to transmit the key announcement message and/or the common network key, the stations 604-614 may be configured to suppress transmission of the key announcement message and/or the common network key. For example, a suppressed key announcement message or a suppressed common network key may not be transmitted to other stations (e.g., the station may determine not to transmit the suppressed key announcement message or the suppressed common network key). The suppressed key announcement message and/or the suppressed common network key may be suppressed (e.g., the suppressed key announcement message and/or the suppressed common network key is not transmitted) prior to an initial transmission or after one or more transmissions (e.g., additional transmissions subsequent to the one or more transmissions are suppressed). Additionally, suppressing the key announcement message and/or the common network key may include discarding (e.g., erasing, deleting, or overwriting in memory) the suppressed key announcement message and/or the suppressed common network key.

During operation, the first station 604 may generate a first common network key (Key₁) 624 at a first time. The first station 604 may generate and initiate transmission of (e.g., broadcast) the first key announcement message (KAN₁) 620 in response to generating the first common network key 624. In a particular embodiment, the first key announcement message 620 includes the first timestamp 630. In an alternate embodiment, the first timestamp 630 is not included in the first key announcement message 620. The first key announcement message 620 may be propagated through the wireless network 602, as described with reference to FIG. 1. For example, the first key announcement message 620 may be transmitted (e.g., broadcast) from station-to-station (e.g., from the first station 604 to the second station 606, from the second station 606 to the third station 608, etc.) as illustrated in FIG. 6. Prior to the first key announcement message reaching the sixth station 614, the sixth station 614 may generate a second common network key (Key₂) 626 and a second key announcement message (KAN₂) 622. For example, a countdown at the sixth station 614 may reach a zero value before the first key announcement message 620 is received. The sixth station 614 may transmit (e.g., broadcast) the second key announcement message 622 to the fifth station 612 for propagation throughout the wireless network 602. In a particular embodiment, the second key announcement message 622 includes the second timestamp 632. In an alternate embodiment, the second timestamp 632 is not included in the second key announcement message 622.

In the illustrated embodiment of FIG. 6, the fourth station 610 may receive the first key announcement message 620 and determine whether to transmit (e.g., forward) the first key announcement message 620 to the fifth station 612. For example, the fourth station 610 may determine to transmit the first key announcement message 620 because the fourth station 610 has not received any key announcement messages prior to receiving the first key announcement message 620. After transmitting the first key announcement message 620, the fourth station 610 may receive the second key announcement message 622. The fourth station 610 may determine whether to transmit (e.g., forward) the second key announcement message 622 based on the at least one key suppression criteria 640. In a particular embodiment, the second common network key 626 meets the at least one key suppression criteria 640 (e.g., the second common network key 626 has a lower priority than the first common network key 624). Accordingly, the fourth station 610 may determine to suppress (e.g., may determine not to transmit) the second common network key 626 and the second common network key 626 is not transmitted to the third station 608. Similarly, the fifth station 612 may receive the first key announcement message 620 after transmitting the second key announcement message 622. Based on the at least one key suppression criteria 640, the fifth station 612 may determine to transmit the first key announcement message 620 to the sixth station 614, even though the fifth station 612 already transmitted the second key announcement message 622 to the fourth station 610. The fifth station 612 may suppress any additional transmissions of the second key announcement message 622.

Common network keys may be suppressed in a similar manner. For example, the fifth station 612 may receive the second common network key 626 prior to receiving the first key announcement message 620. When the fifth station 612 receives and determines not to suppress the first key announcement message 620, the fifth station 612 may discard (e.g., erase, overwrite, remove, etc.) the second common network key 626. In an alternate example, the fifth station 612 may receive the first key announcement message 620 prior to receiving the second common network key 626. In this example, the fifth station 612 may determine not to store or to transmit the second common network key 626 based on the at least one key suppression criteria 640.

Due to key suppression performed by the stations 604-614, a single common network key 624 and a single key announcement message 620 are propagated throughout the wireless network 602. In an alternate embodiment, the second common network key 626 may have a higher priority than the first common network key 624, and the stations 604-614 may suppress the first common network key 624 and the first key announcement message 620. Thus, the system 600 enables use of a single common network key in the wireless network 602 without designating a particular station (e.g., a central station) to generate the common network key.

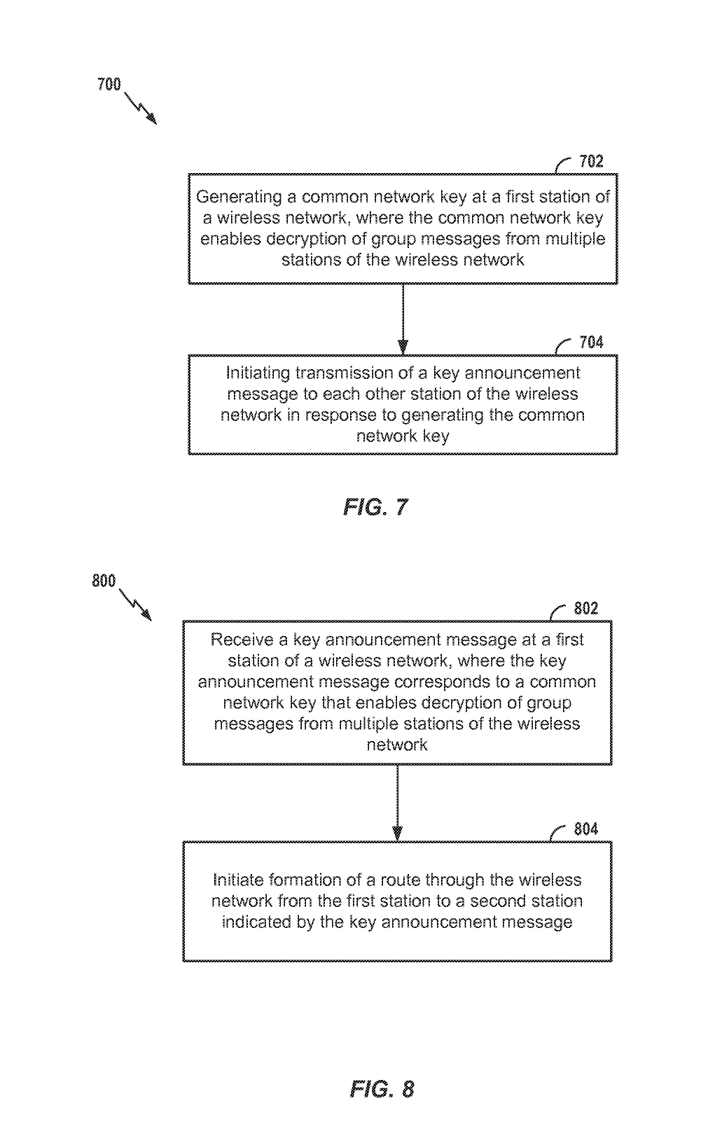

Referring to FIG. 7, a particular embodiment of a method 700 of transmitting a key announcement message in a wireless network is described. The method 700 may be performed using the stations 104-110 of FIG. 1 and FIG. 3, the station 402 of FIG. 4, or the stations 604-614 of FIG. 6, and the wireless network may include or correspond to the wireless network 102 of FIGS. 1 and 3 or the wireless network 602 of FIG. 6.

The method 700 may include generating a common network key at a first station of the wireless network, at 702. For example, the common network key may include or correspond to the common network key 112 of FIGS. 1 and 3, the common network key 414 of FIG. 4, or the first common network key 624 of FIG. 6. In a particular embodiment, a group message may be encrypted based on the common network key and the first station may initiate transmission of the group message to a plurality of stations of the wireless network. For example, the group message may include or correspond to the group message 134 of FIG. 1. In a particular embodiment, the wireless network includes a wireless mesh network, such as an IEEE 802.11s wireless mesh network. In another particular embodiment, the wireless network includes a peer-to-peer, infrastructure-less wireless network. In yet another particular embodiment, the wireless network includes a data path group of a neighbor aware network (NAN). The data path group may include or be referred to as a “social wi-fi mesh network.”

The method 700 may further include initiating transmission of a key announcement message to each other station of the wireless network in response to generating the common network key, at 704. For example, the key announcement message may include or correspond to the key announcement message 114 of FIGS. 1 and 3 or the first key announcement message 620 of FIG. 6. In a particular embodiment, the key announcement message may be encrypted based on a “current” common network key stored at the first station prior to a time when the common network key originated. The current common network key may be valid until propagation of the common network key to stations of the wireless network is complete (e.g., prior to the common network key becoming “effective”). For example, with reference to FIG. 1, the key announcement message 114 may be encrypted based on the second common network key 130, which is a current common network key at a particular time when the key announcement message 114 is generated. In another particular embodiment, the key announcement message may be transmitted during a time period of active stations (e.g., a paging window) associated with the wireless network. Each station in the wireless network may be configured to receive messages during the time period of active stations. Additionally or alternatively, a bit value of a flag field of the key announcement message may indicate an upcoming transmission of the common network key. For example, the key announcement message may include an Institute of Electrical and Electronics Engineers (IEEE) 802.11s root announcement (RANN) message. The bit value may be a value of a reserved bit of the flag field of the IEEE 802.11s RANN message.

In a particular embodiment, the common network key is associated with a group of stations that includes the multiple stations, and the common network key enables secure communications between stations of the group via the wireless network. For example, with reference to FIG. 1, stations 104-110 may be included in a group of stations associated with the common network key 112 (e.g., a group of stations to which the common network key 112 and the key announcement message 114 are to be transmitted). Because group messages communicated between the stations 104-110 are encrypting using the common network key 112, the common network key 112 may enable secure communications between the stations 104-110.

In a particular embodiment, the first station may authenticate a second station of the wireless network and may transmit the common network key to the second station via a secure unicast transmission. Additionally, the common network key may be encrypted based on a shared key that is establish by the first station and the second station during an authentication and security association process. For example, the first station 104 and the second station 106 may perform an authentication and security association process, and the common network key 112 may be encrypted based on a shared key that is generated and shared between the first station 104 and the second station 106 during the authentication and security association process. The shared key may be based on a group authentication key, a password, a secret credential, or a combination thereof, as non-limiting examples. The authentication and security association process may involve a 4-way handshake protocol to establish a pairwise traffic key (PTK) (e.g., the shared key). In a particular embodiment, the 4-way handshake protocol may be specified in the IEEE 802.11ai standard. In another particular embodiment, the 4-way handshake protocol may be a modified IEEE 802.11ai 4-way handshake protocol. The second station may be within one hop of the first station in the wireless network. Additionally or alternatively, the first station may transmit a time stamp with the common network key to the second station. The time stamp (e.g., the timestamp 150) may indicate a time when the common network key originated.

In another particular embodiment, the key announcement message includes a service discovery message. The key announcement message may be transmitted to devices of a neighbor aware network (NAN). For example, with reference to FIG. 1, the stations 104, 106, 108, and 110 may be part of a NAN as well as the wireless network 102. One or more wireless channels (e.g., one or more NAN channels) may be reserved for discovery operations and synchronization operations within the NAN, and the key announcement message 114 may be transmitted as a service discovery message via a NAN channel to the stations 106, 108, and 110.

In another particular embodiment, the method 700 further includes determining an expiration time of a second common network key that is stored at the first station. The second common network key may be a “current” common network key that is valid until propagation of the common network key to stations of the wireless network is complete (e.g., prior to the common network key becoming “effective”). In this embodiment, the method 700 further includes initiating transmission of the key announcement message prior to the expiration time of the second common network key. For example, with reference to FIG. 1, the first station 104 may store the second common network key 130. The second common network key 130 may be a current common network key in use by stations of the wireless network 102 when the key announcement message 114 and the common network key 112 are generated. A message received at the first station 104 prior to generating the common network key 112 may be encrypted based on the second common network key 130, and the second common network key 130 may not have expired (e.g., may be “current” or “in use”) at the stations 104-110 prior to generating the key announcement message 114 and the common network key 112. The first station 104 may initiate transmission of the key announcement message 114 and may determine to generate the common network key 112 prior to an expiration time of the second common network key 130.

The method 700 may enable the first station to transmit a key announcement message to indicate to one or more other stations that a common network key has been or is to be generated.

Referring to FIG. 8, a particular embodiment of a method 800 of transmitting a common network key in a wireless network is described. The method 800 may be performed using the stations 104-110 of FIG. 1 and FIG. 3, the station 402 of FIG. 4, or the stations 604-614 of FIG. 6, and the wireless network may include or correspond to the wireless network 102 of FIGS. 1 and 3 or the wireless network 602 of FIG. 6.

The method 800 may include receiving a key announcement message at a first station of a wireless network, at 802. For example, the key announcement message may include or correspond to the key announcement message 114 of FIGS. 1 and 3 or the first key announcement message 620 of FIG. 6. The key announcement message may correspond to a common network key that enables decryption of group messages from multiple stations of the wireless network. For example, the common network key may include or correspond to the common network key 112 of FIGS. 1 and 3, the common network key 414 of FIG. 4, or the first common network key 624 of FIG. 6. In a particular embodiment, the key announcement message may be decrypted based on a key (e.g., a previous common network key) stored at the first station. The key announcement message and the common network key may be received from a second station of the wireless network prior to expiration of the key stored at the first station. In a particular embodiment, the key announcement message is received during a time period of active stations (e.g., a paging window) associated with the wireless network.

The method 800 may further include initiating formation of a route through the wireless network from the first station to a second station of the wireless network indicated by the key announcement message, at 804. The second station may have generated the key announcement message. For example, with reference to FIG. 3, the third station 108 may form a route through the wireless network 102 from the third station 108 to the first station 104 (e.g., the station that generated the key announcement message 114). In a particular embodiment, the route is a unicast route. Additionally or alternatively, the first station may authenticate a third station along the unicast route that is within one hop of the first station in the wireless network and may request the common network key via the third station. For example, with reference to FIG. 3, the second station 106 may be within one hop of the third station 108 and the third station 108 may authenticate the second station 106 and request the common network key 112 from the second station 106.

In a particular embodiment, the method 800 includes decrypting a key announcement message based on a key stored at the first station when the key announcement message is encrypted. For example, with reference to FIG. 1, the third station 108 may store the second common network key 130 and may decrypt the key announcement message 114 based on the second common network key 130.

The method 800 may enable the first station to receive a key announcement message to indicate to that a second station has generated a common network key.

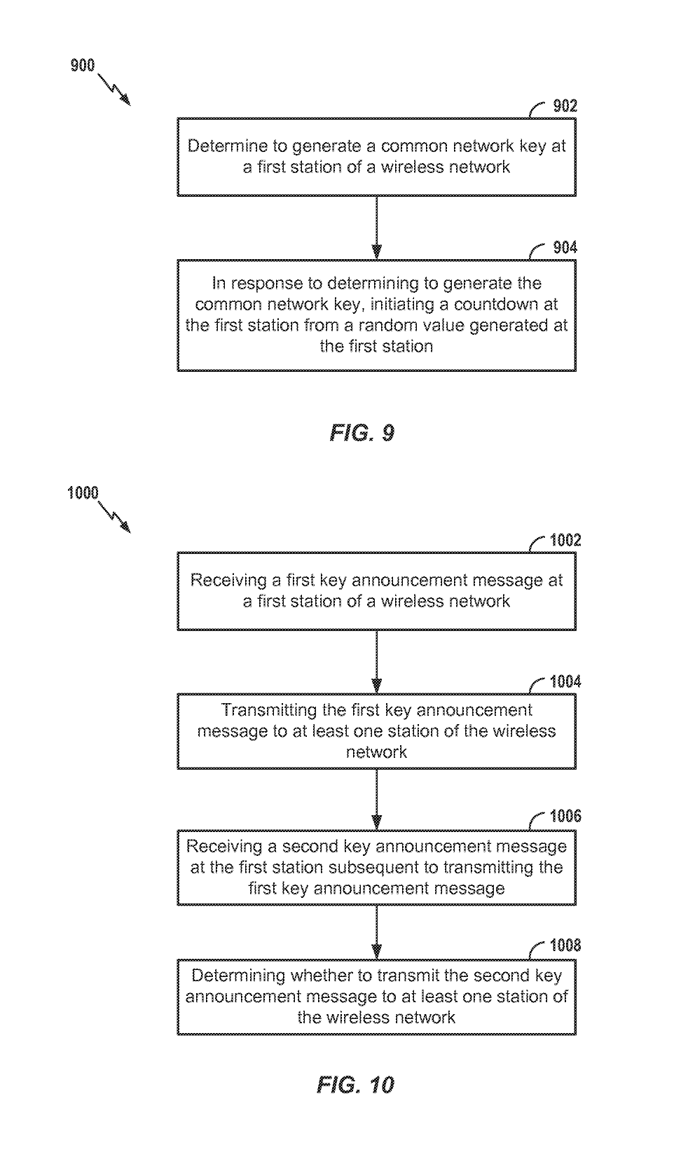

Referring to FIG. 9, a particular embodiment of a method 900 of generating a common network key in a wireless network is described. The method 900 may be performed using the stations 104-110 of FIG. 1 and FIG. 3, the station 402 of FIG. 4, or the stations 604-614 of FIG. 6, and the wireless network may include or correspond to the wireless network 102 of FIGS. 1 and 3 or the wireless network 602 of FIG. 6.

The method 900 may include determining to generate a common network key at a first station of the wireless network, at 902. For example, the common network key may include or correspond to the common network key 112 of FIGS. 1 and 3, the common network key 414 of FIG. 4, or the first common network key 624 of FIG. 6.

The method 900 may further include in response to determining to generate the common network key, initiating a countdown at the first station from a random value generated at the first station, at 904. In a particular embodiment, determining to generate the common network key may be based on an expiration indicator associated with a key (e.g., a previous common network key) stored at the first station. The expiration indicator may be detected at the first station. The expiration indicator may include a threshold amount of time that remains before expiration of the key. Additionally or alternatively, the expiration indicator may include a particular number of stations that joined the wireless network subsequent to a particular time when the key originated. Additionally or alternatively, the expiration indicator may include a particular number of stations that exited the wireless network subsequent to a particular time when the key originated.

In a particular embodiment, the random value is selected from within a particular range of values, and data indicating the particular range of values is stored at each station of a group of stations associated with the common network key. For example, with reference to FIG. 1, each of the stations 104-110 may represent a group of stations associated with the common network key 112, and each of the stations 104-110 may store data (e.g., the value range data 142) indicating a particular range of values from which to randomly select a countdown value (e.g., the random value 140). For example, the range of values (e.g., the value range data 142) may be programmed into memories of the stations 104-110 during manufacturing or may be received from a particular station of the group of stations. The range of values may be specified in one or more standards, such as an IEEE 802.11 standard or a Wi-Fi Alliance standard.

In a particular embodiment, the first station may generate the common network key when the countdown reaches a zero value. Additionally or alternatively, the first station may stop the countdown in response to receiving a key announcement message from a second station of the wireless network prior to completion of the countdown. Stopping the countdown may prohibit the common network key from being generated. In another particular embodiment, the first station may transmit a key announcement message to multiple stations in the wireless network in response to generating the common network key.

In another particular embodiment, the method 900 includes detecting an expiration indicator associated with the common network key, determining whether a ranking (e.g., a NAN master device rank) corresponding to the first station exceeds rankings corresponding to other stations of a NAN, and determining to generate a second common network key in response to determining that the ranking corresponding to the first station exceeds the rankings corresponding to the other stations. For example, with reference to FIG. 1, the first station 104 may store a NAN master rank 132. In response to determining that the NAN master rank 132 exceeds NAN master ranks of other stations (e.g., the stations 106-110), the first station 104 determines to generate the key announcement message 114 and the common network key 112.

The method 900 may enable the first station to generate a common network key at a different time than a second station in the wireless network using a countdown from a random value.

Referring to FIG. 10, a particular embodiment of a method 1000 of suppressing one or more common network keys in a wireless network is described. The method 1000 may be performed using the stations 104-110 of FIG. 1 and FIG. 3, the station 402 of FIG. 4, or the stations 604-614 of FIG. 6, and the wireless network may include or correspond to the wireless network 102 of FIGS. 1 and 3 or the wireless network 602 of FIG. 6.

The method 1000 may include receiving a first key announcement message at a first station of a wireless network, at 1002. For example, the first key announcement message may include or correspond to the key announcement message 114 of FIGS. 1 and 3 or the first key announcement message 620 of FIG. 6.

The method 1000 may include transmitting the first key announcement message to at least one station of the wireless network, at 1004. The method 1000 may include receiving a second key announcement message at the first station subsequent to transmitting the first key announcement message, at 1006. For example, the second key announcement message may include or correspond to the second key announcement message 622 of FIG. 6.

The method 1000 may further include determining whether to transmit the second key announcement message to the at least one station of the wireless network, at 1008. In a particular embodiment, determining whether to transmit the second key announcement message may be based on at least one suppression criteria. For example, with reference to FIG. 6, the fifth station 612 may determine whether to transmit the second key announcement message 622 based on the at least one key suppression criteria 640. In a particular embodiment, the at least one suppression criteria may be based on whether the second key announcement message was generated before the first key announcement message.

Determining whether the second key announcement message was generated before a time when the first key announcement message originated may be based on a comparison of a first timestamp associated with the first key announcement message and a second timestamp associated with the second key announcement message. For example, with reference to FIG. 6, the at least one key suppression criteria 640 may be based on a comparison of the first time stamp 630 to the second timestamp 632. Additionally or alternatively, the at least one suppression criteria may be based on whether the second key announcement message was generated after the first key announcement message.

Additionally or alternatively, the at least one suppression criteria may be based on a media access control (MAC) address included in the second key announcement message (e.g., in the root station address field 212 of FIG. 2). Additionally or alternatively, the at least one suppression criteria may be based on whether a second station that generated the second key announcement message has greater network seniority (e.g., priority) than a third station that generated the first key announcement message. Additionally or alternatively, the at least one suppression criteria may be based on comparison between a threshold and a difference between a timestamp included in the second key announcement message and a time indicator of a current time at the first station. For example, with reference to FIG. 6, the at least one key suppression criteria 640 may be based on whether a difference between the second timestamp 632 of the second key announcement message 622 and a time indicator of a current time determined at the fifth station 612 exceeds a threshold.

In a particular embodiment, the first station may, in response to determining to transmit the second key announcement message, delete the first key announcement message and transmit the second key announcement message to the at least one station of the wireless network. The first station may further receive a first common network key associated with the first key announcement message, determine not to transmit the first common network key, and delete the first common network key. The first station may further receive a second common network key associated with the second key announcement message and may transmit the second common network key to the at least one station of the wireless network. The second common network key may be stored at the first station.

In a particular embodiment, the first station may suppress delete the second key announcement message in response to determining not to transmit the second key announcement message. The first station may further receive a first common network key associated with the first key announcement message and may transmit the first common network key to the at least one station of the wireless network. The first common network key may be stored at the first station. Additionally or alternatively, the first station may receive a second common network key associated with the second key announcement message and may determine not to transmit the second common network key.

The method 1000 may enable the first station to suppress transmission of one or more key announcement messages and one or more common network keys based on suppression criteria.

Referring to FIG. 11, a particular illustrative embodiment of a wireless communication device is depicted and generally designated 1100. The device 1100 includes a processor 1110, such as a digital signal processor, coupled to a memory 1132. In an illustrative embodiment, the device 1100, or components thereof, may correspond to the stations 104-110 of FIG. 1 and FIG. 3, the station 402 of FIG. 4, the stations 604-614 of FIG. 6, or components thereof.

The processor 1110 may be configured to execute software (e.g., a program of one or more instructions 1168) stored in the memory 1132. Additionally or alternatively, the processor 1110 may be configured to implement one or more instructions stored in a memory of a wireless interface 1140 (e.g., an IEEE 802.11 wireless interface or a Wi-Fi Alliance-compliant interface). In a particular embodiment, the processor 1110 may be configured to operate in accordance with one or more of the methods of FIGS. 7-10. For example, the processor 1110 may include common network key generation logic 1164 to execute one or more of the methods of FIGS. 7-10. The processor 1110 may also be configured to generate and store a common network key 1170 associated with devices or data transmissions associated with a wireless network. In an illustrative embodiment, the common network key 1170 may be used in the wireless network 102 of FIGS. 1 and 3 or the wireless network 602 of FIG. 6.

The wireless interface 1140 may be coupled to the processor 1110 and to an antenna 1142. For example, the wireless interface 1140 may be coupled to the antenna 1142 via a transceiver 1146, such that wireless data received via the antenna 1142 and may be provided to the processor 1110.

A coder/decoder (CODEC) 1134 can also be coupled to the processor 1110. A speaker 1136 and a microphone 1138 can be coupled to the CODEC 1134. A display controller 1126 can be coupled to the processor 1110 and to a display device 1128. In a particular embodiment, the processor 1110, the display controller 1126, the memory 1132, the CODEC 1134, and the wireless interface 1140, are included in a system-in-package or system-on-chip device 1122. In a particular embodiment, an input device 1130 and a power supply 1144 are coupled to the system-on-chip device 1122. Moreover, in a particular embodiment, as illustrated in FIG. 11, the display device 1128, the input device 1130, the speaker 1136, the microphone 1138, the antenna 1142, and the power supply 1144 are external to the system-on-chip device 1122. However, each of the display device 1128, the input device 1130, the speaker 1136, the microphone 1138, the antenna 1142, and the power supply 1144 can be coupled to one or more components of the system-on-chip device 1122, such as one or more interfaces or controllers.

In conjunction with the described embodiments, a first apparatus includes means for generating a common network key at a first station of a wireless network, where the common network key may enable decryption of group messages from multiple stations of a wireless network. For example, the means for generating may include the stations 104-110 of FIG. 1 and FIG. 3, the station 402 of FIG. 4, the stations 604-614 of FIG. 6, the wireless interface 1140, the processor 1110 programmed to execute the instructions 1168, the common network key generation logic 1164 of FIG. 11, one or more other devices, circuits, modules, or instructions to generate a common network key at a first station of a wireless network, or any combination thereof

The first apparatus also includes means for initiating transmission of a key announcement message to each other station of the wireless network in response to generating the common network key. For example, the means for initiating may include the stations 104-110 of FIG. 1 and FIG. 3, the station 402 of FIG. 4, the stations 604-614 of FIG. 6, the wireless interface 1140, the processor 1110 programmed to execute the instructions 1168, the common network key generation logic 1164 of FIG. 11, one or more other devices, circuits, modules, or instructions to initiate transmission of a key announcement message to each other station of a wireless network, or any combination thereof

In conjunction with the described embodiments, a second apparatus includes means for receiving a key announcement message at a first station of a wireless network, where the key announcement message corresponds to a common network key that enables decryption of group messages from multiple stations of a wireless network. For example, the means for receiving may include the stations 104-110 of FIG. 1 and FIG. 3, the station 402 of FIG. 4, the stations 604-614 of FIG. 6, the wireless interface 1140, the processor 1110 programmed to execute the instructions 1168, the common network key generation logic 1164 of FIG. 11, one or more other devices, circuits, modules, or instructions to receive a key announcement message at a station of a wireless network, or any combination thereof.

The second apparatus also includes means for initiating formation of a unicast route through the wireless network to a particular station indicated by the key announcement message. For example, the means for initiating may include the stations 104-110 of FIG. 1 and FIG. 3, the station 402 of FIG. 4, the stations 604-614 of FIG. 6, the wireless interface 1140, the processor 1110 programmed to execute the instructions 1168, the common network key generation logic 1164 of FIG. 11, one or more other devices, circuits, modules, or instructions to initiate formation of a unicast route through the wireless network to a particular station, or any combination thereof

In conjunction with the described embodiments, a third apparatus includes means for determining to generate a common network key at a first station of a wireless network. For example, the means for determining may include the stations 104-110 of FIG. 1 and FIG. 3, the station 402 of FIG. 4, the stations 604-614 of FIG. 6, the wireless interface 1140, the processor 1110 programmed to execute the instructions 1168, the common network key generation logic 1164 of FIG. 11, one or more other devices, circuits, modules, or instructions to determine to generate a common network key at a station of a wireless network, or any combination thereof

The third apparatus also includes means for initiating a countdown at the first station from a random value generated at the first station in response to determining to generate the common network key. For example, the means for initiating may include the stations 104-110 of FIG. 1 and FIG. 3, the station 402 of FIG. 4, the stations 604-614 of FIG. 6, the wireless interface 1140, the processor 1110 programmed to execute the instructions 1168, the common network key generation logic 1164 of FIG. 11, one or more other devices, circuits, modules, or instructions to initiate a countdown from a random value, or any combination thereof.

In conjunction with the described embodiments, a fourth apparatus includes means for receiving a first key announcement message at a first station of a wireless network. For example, the means for receiving may include the stations 104-110 of FIG. 1 and FIG. 3, the station 402 of FIG. 4, the stations 604-614 of FIG. 6, the wireless interface 1140, the processor 1110 programmed to execute the instructions 1168, the common network key generation logic 1164 of FIG. 11, one or more other devices, circuits, modules, or instructions to receive a first key announcement message at a station of a wireless network, or any combination thereof.

The fourth apparatus also includes means for transmitting the first key announcement message to at least one station of the wireless network. For example, the means for transmitting may include the stations 104-110 of FIG. 1 and FIG. 3, the station 402 of FIG. 4, the stations 604-614 of FIG. 6, the wireless interface 1140, the processor 1110 programmed to execute the instructions 1168, the common network key generation logic 1164 of FIG. 11, one or more other devices, circuits, modules, or instructions to transmit a first key announcement message to at least one station of a wireless network, or any combination thereof.

The fourth apparatus also includes means for receiving a second key announcement message at the first station subsequent to transmitting the first key announcement message. For example, the means for receiving may include the stations 104-110 of FIG. 1 and FIG. 3, the station 402 of FIG. 4, the stations 604-614 of FIG. 6, the wireless interface 1140, the processor 1110 programmed to execute the instructions 1168, the common network key generation logic 1164 of FIG. 11, one or more other devices, circuits, modules, or instructions to receive a second key announcement message at a station of a wireless network subsequent to transmitting a first key announcement message, or any combination thereof.

The fourth apparatus also includes means for determining whether to transmit the second key announcement message to the at least one station of the wireless network. For example, the means for determining may include the stations 104-110 of FIG. 1 and FIG. 3, the station 402 of FIG. 4, the stations 604-614 of FIG. 6, the wireless interface 1140, the processor 1110 programmed to execute the instructions 1168, the common network key generation logic 1164 of FIG. 11, one or more other devices, circuits, modules, or instructions to determine whether to transmit a second key announcement message to at least one station of a wireless network, or any combination thereof.

Those of skill in the art would further appreciate that the various illustrative logical blocks, configurations, modules, circuits, and algorithm steps described in connection with the embodiments disclosed herein may be implemented as electronic hardware, computer software executed by a processor, or combinations of both. Various illustrative components, blocks, configurations, modules, circuits, and steps have been described above generally in terms of their functionality. Whether such functionality is implemented as hardware or processor executable instructions depends upon the particular application and design constraints imposed on the overall system. Skilled artisans may implement the described functionality in varying ways for each particular application, but such implementation decisions should not be interpreted as causing a departure from the scope of the present disclosure.

The steps of a method or algorithm described in connection with the embodiments disclosed herein may be embodied directly in hardware, in a software module executed by a processor, or in a combination of the two. A software module may reside in random access memory (RAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of non-transient (e.g., non-transitory) storage medium known in the art. An exemplary storage medium is coupled to the processor such that the processor can read information from, and write information to, the storage medium. In the alternative, the storage medium may be integral to the processor. The processor and the storage medium may reside in an application-specific integrated circuit (ASIC). The ASIC may reside in a computing device or a user terminal. In the alternative, the processor and the storage medium may reside as discrete components in a computing device or user terminal.

The previous description of the disclosed embodiments is provided to enable a person skilled in the art to make or use the disclosed embodiments. Various modifications to these embodiments will be readily apparent to those skilled in the art, and the principles defined herein may be applied to other embodiments without departing from the scope of the disclosure. Thus, the present disclosure is not intended to be limited to the embodiments shown herein but is to be accorded the widest scope possible consistent with the principles and novel features as defined by the following claims.

What is claimed is:

1. A method comprising:
generating a common network key at a first station of a wireless network, wherein the common network key enables decryption of group messages from multiple stations of the wireless network; and
initiating transmission of a key announcement message to each other station of the wireless network in response to generating the common network key.

2. The method of claim 1, further comprising:
encrypting a group message based on the common network key; and
initiating transmission of the group message to a plurality of stations of the wireless network.

3. The method of claim 1, wherein the wireless network includes a wireless mesh network.

4. The method of claim 1, wherein the wireless network includes a peer-to-peer, infrastructure-less wireless network.

5. The method of claim 1, wherein the wireless network includes a data path group of a neighbor aware network (NAN).

6. The method of claim 1, wherein the common network key is associated with a group of stations that includes the multiple stations, and wherein the common network key enables secure communications between stations of the group of stations via the wireless network.

7. The method of claim 1, wherein the key announcement message comprises a service discovery message, and wherein the key announcement message is transmitted to devices of a neighbor aware network (NAN).

8. The method of claim 1, further comprising:
determining an expiration time of a second common network key that is stored at the first station, wherein the second common network key is valid until propagation of the common network key to stations of the wireless network is complete; and
initiating transmission of the key announcement message prior to the expiration time of the second common network key.

9. The method of claim 1, further comprising:
authenticating a second station of the wireless network; and
transmitting the common network key to the second station via a secure unicast transmission.

10. The method of claim 9, wherein the common network key is encrypted based on a pairwise traffic key established by the first station and the second station during an authentication and security association process.

11. The method of claim 9, wherein the second station is within one hop of the first station in the wireless network.

12. The method of claim 9, further comprising transmitting a timestamp corresponding to the common network key to the second station.

13. A method comprising:
receiving a key announcement message at a first station of a wireless network, wherein the key announcement message corresponds to a common network key that enables decryption of group messages from multiple stations of the wireless network; and
initiating formation of a route through the wireless network from the first station to a second station indicated by the key announcement message.

14. The method of claim 13, further comprising:
authenticating a third station along the route, wherein the route is a unicast route, wherein the second station generated the key announcement message, and wherein the third station is within one hop of the first station in the wireless network; and
requesting the common network key via the third station.

15. The method of claim 13, further comprising:
decrypting the key announcement message based on a key stored at the first station when the key announcement message is encrypted; and
receiving the common network key from the second station of the wireless network, wherein the key announcement message and the common network key are received prior to expiration of the key stored at the first station.

16. A method comprising:
determining to generate a common network key at a first station of a wireless network; and
in response to determining to generate the common network key, initiating a countdown at the first station from a random value generated at the first station.

17. The method of claim 16, further comprising detecting an expiration indicator associated with a key stored at the first station, wherein determining to generate the common network key is based on detection of the expiration indicator.

18. The method of claim 17, wherein the expiration indicator comprises a threshold amount of time that remains before expiration of the key.

19. The method of claim 16, further comprising:
generating the common network key in response to the countdown reaching a zero value; and
transmitting a key announcement message to multiple stations of the wireless network in response to generating the common network key.

20. The method of claim 16, further comprising stopping the countdown in response to receiving a key announcement message from a second station of the wireless network prior to completion of the countdown.

21. The method of claim 16, further comprising:
detecting an expiration indicator associated with the common network key;
determining whether a ranking corresponding to the first station exceeds rankings corresponding to other stations of a neighbor aware network (NAN), wherein the ranking indicates a master device rank of the first station within the NAN; and
determining to generate a second common network key in response to determining that the ranking of the first station exceeds the rankings of the other stations.

22. A method comprising:
receiving a first key announcement message at a first station of a wireless network;
transmitting the first key announcement message to at least one station of the wireless network;
receiving a second key announcement message at the first station subsequent to transmitting the first key announcement message; and
determining whether to transmit the second key announcement message to the at least one station of the wireless network.

23. The method of claim 22, wherein determining whether to transmit the second key announcement message is based on at least one suppression criteria.

24. The method of claim 23, wherein the at least one suppression criteria is based on whether the second key announcement message was generated before the first key announcement message, and wherein determining whether the second key announcement message was generated before the first key announcement message is based on a comparison of a first timestamp associated with the first key announcement message and a second timestamp associated with the second key announcement message.

25. The method of claim 23, wherein the at least one suppression criteria is based on a priority of a second station that generated the second key announcement message and a priority of a third station that generated the first key announcement message, a comparison between a threshold and a difference between a timestamp included in the second key announcement message and a time indication at the first station, or a combination thereof.

26. The method of claim 22, further comprising, in response to determining to transmit the second key announcement message:
deleting the first key announcement message; and
transmitting the second key announcement message to the at least one station of the wireless network.

27. The method of claim 26, further comprising:
receiving a first common network key associated with the first key announcement message;
determining not to transmit the first common network key; and
deleting the first common network key.

28. The method of claim 22, further comprising:
receiving a first common network key associated with the first key announcement message;
transmitting the first common network key to the at least one station of the wireless network; and
storing the first common network key at the first station.

29. The method of claim 28, further comprising:
receiving a second common network key associated with the second key announcement message; and
determining not to transmit the second common network key.

30. An apparatus comprising:
a processor; and
a memory coupled to the processor, wherein the memory stores instructions that are executable by the processor to perform operations comprising:
generating a common network key at a first station of a wireless network, wherein the common network key enables decryption of group messages from multiple stations of the wireless network; and
initiating transmission of a key announcement message to each other station of the wireless network in response to generating the common network key.

31. The apparatus of claim 30, wherein a bit value of a flag field of the key announcement message indicates an upcoming transmission of the common network key, and wherein the bit value is a value of a reserved bit of the flag field of an Institute of Electrical and Electronics Engineers (IEEE) 802.11s root announcement (RANK) message.

32. An apparatus comprising:
means for generating a common network key at a first station of a wireless network, wherein the common network key enables decryption of group messages from multiple stations of the wireless network; and
means for initiating transmission of a key announcement message to each other station of the wireless network in response to generating the common network key.

33. The apparatus of claim 32, wherein the key announcement message is transmitted during a time period of active stations of the wireless network.

34. A non-transitory computer readable medium comprising instructions that, when executed by a processor, cause the processor to:
generate a common network key at a first station of a wireless network, wherein the common network key enables decryption of group messages from multiple stations of the wireless network; and
initiate transmission of a key announcement message to each other station of the wireless network in response to generating the common network key.

35. The non-transitory computer readable medium of claim 34, wherein the key announcement message is encrypted based on a current common network key stored at the first station, and wherein the current common network key is valid until propagation of the common network key to stations of the wireless network is complete.

36. An apparatus comprising:
a processor; and
a memory coupled to the processor, wherein the memory stores instructions that are executable by the processor to perform operations comprising:
receiving a key announcement message at a first station of a wireless network, wherein the key announcement message corresponds to a common network key that enables decryption of group messages from multiple stations of the wireless network; and
initiating formation of a unicast route through the wireless network to a second station indicated by the key announcement message.

37. The apparatus of claim 36, wherein the operations further comprise:
authenticating a third station along the unicast route, wherein the third station is within one hop of the first station in the wireless network; and
requesting the common network key via the third station.

38. An apparatus comprising:
means for receiving a key announcement message at a first station of a wireless network, wherein the key announcement message corresponds to a common network key that enables decryption of group messages from multiple stations of the wireless network; and
means for initiating formation of a unicast route through the wireless network to a particular station indicated by the key announcement message.

39. The apparatus of claim 38, wherein the key announcement message is received during a time period of active stations of the wireless network.

40. A non-transitory computer readable medium comprising instructions that, when executed by a processor, cause the processor to:
receive a key announcement message at a first station of a wireless network, wherein the key announcement message corresponds to a common network key that enables decryption of group messages from multiple stations of the wireless network; and
initiate formation of a unicast route through the wireless network to a particular station indicated by the key announcement message.

41. The non-transitory computer readable medium of claim 40, wherein the instructions, when executed by the processor, further cause the processor to decrypt the key announcement message based on a key stored at the first station when the key announcement message is encrypted.

42. An apparatus comprising:
a processor; and
a memory coupled to the processor, wherein the memory stores instructions that are executable by the processor to perform operations comprising:
determining to generate a common network key at a first station of a wireless network; and
in response to determining to generate the common network key, initiating a countdown at the first station from a random value generated at the first station.

43. The apparatus of claim 42, wherein the operations further comprise detecting an expiration indicator associated with a key stored at the first station, wherein determining to generate the common network key is based on detecting the expiration indicator, and wherein the expiration indicator comprises a particular number of stations that joined the wireless network subsequent to a particular time when the key originated.

44. An apparatus comprising:
means for determining to generate a common network key at a first station of a wireless network; and
means for initiating a countdown at the first station from a random value generated at the first station in response to determining to generate the common network key.

45. The apparatus of claim 44, wherein the random value is selected from within a particular range of values, and wherein data indicating the particular range of values is stored at each station of a group of stations associated with the common network key.

46. A non-transitory computer readable medium comprising instructions that, when executed by a processor, cause the processor to:
determine to generate a common network key at a first station of a wireless network; and
initiate a countdown at the first station from a random value generated at the first station in response to determining to generate the common network key.

47. The non-transitory computer readable medium of claim 46, wherein the instructions, when executed by the processor, further cause the processor to detect an expiration indicator associated with a key stored at the first station, wherein determining to generate the common network key is based on detection of the expiration indicator, and wherein the expiration indicator comprises a particular number of stations that exited the wireless network subsequent to a particular time when the key originated.

48. An apparatus comprising:
a processor; and
a memory coupled to the processor, wherein the memory stores instructions that are executable by the processor to perform operations comprising:
receiving a first key announcement message at a first station of a wireless network;
transmitting the first key announcement message to at least one station of the wireless network;
receiving a second key announcement message at the first station subsequent to transmitting the first key announcement message; and
determining whether to transmit the second key announcement message to the at least one station of the wireless network.

49. The apparatus of claim 48, wherein the operations further comprise, in response to determining to transmit the second key announcement message:
deleting the first key announcement message;
transmitting the second key announcement message to the at least one station of the wireless network;
receiving a common network key associated with the second key announcement message;
transmitting the common network key to the at least one station of the wireless network; and
storing the common network key at the first station.

50. An apparatus comprising:
means for receiving a first key announcement message at a first station of a wireless network;
means for transmitting the first key announcement message to at least one station of the wireless network;
means for receiving a second key announcement message at the first station subsequent to transmitting the first key announcement message; and
means for determining whether to transmit the second key announcement message to the at least one station of the wireless network.

51. The apparatus of claim 50, wherein determining whether to transmit the second key announcement message is based on at least one suppression criteria, wherein the at least one suppression criteria is based on whether the second key announcement message was generated after the first key announcement message, a media access control (MAC) address included in the second key announcement message, or a combination thereof.

52. A non-transitory computer readable medium comprising instructions that, when executed by a processor, cause the processor to:
receive a first key announcement message at a first station of a wireless network;
transmit the first key announcement message to at least one station of the wireless network;
receive a second key announcement message at the first station subsequent to transmitting the first key announcement message; and
determine whether to transmit the second key announcement message to the at least one station of the wireless network.

53. The non-transitory computer readable medium of claim 52, wherein the instructions, when executed by the processor, further cause the processor to delete the second key announcement message in response to determining not to transmit the second key announcement message.
